(19) United States
(12) Patent Application Publication
(10) Pub. No.: US 2018/0187737 A1
(43) Pub. Date: Jul. 5, 2018

(54) Frequency-Dependent Damping Valve Arrangement

(71) Applicant: ZF FRIEDRICHSHAFEN AG, Friedrichshafen (DE)

(72) Inventors: Andreas FÖRSTER, Schweinfurt (DE); Andreas SIEBER, Schweinfurt (DE)

(21) Appl. No.: 15/315,684

(22) PCT Filed: Apr. 27, 2015
(86) PCT No.: PCT/EP2015/059017

§ 371 Date: Dec. 1, 2016

(30) Foreign Application Priority Data
Jun. 5, 2014 (DE) 10 2014 210 705.9

(51) Int. Cl. F16F 9/348; F16F 9/512

(52) U.S. Cl. CPC F16F 9/3488; F16F 2228/08; F16F 2228/066; F16F 9/5126

(57) ABSTRACT

A damping valve arrangement for a vibration damper includes a damping piston with a check valve and a control arrangement with a control piston. A spring element is arranged between the control piston and the check valve that loads a valve disk axially in direction of a flow channel and the control piston in direction of the pot base 30 with a defined spring force. A surface of the control piston facing the control space is greater than a surface of the valve disk bounded by the flow channel. A smallest cross-sectional area Az of the inlet connection opening into the control space and a smallest cross-sectional area Aa of the outlet connection leading out of the control space are dimensioned such that their ratio to one another is between 0.2 and 5 according to the condition Az/\sqrt{Aa}.

### CROSS REFERENCE TO RELATED APPLICATIONS

This is a U.S. national stage of application No. PCT/EP2015/059017, filed on Apr. 27, 2015. Priority is claimed on German Application No. DE102014210705.9, filed Jun. 5, 2014, the content of which is/are incorporated here by reference.

### BACKGROUND OF THE INVENTION

### 1. Field of the Invention

The invention is directed to a damping valve arrangement with a frequency-dependent damping force characteristic.

### 2. Description of Prior Art

A vibration damper in a motor vehicle is provided to damp vibrations excited by the uneven road surface. In doing so, there must always be a compromise between driving safety and driving comfort. A vibration damper with a stiff damping valve arrangement having a high damping force characteristic is optimal for high driving safety. If greater comfort is demanded, the damping valve arrangement should be adjusted to be as soft as possible. It is very difficult to find this compromise in a vibration damper with a conventional, non-electronic damping valve arrangement that is adjustable by an actuator.

Present-day vibration dampers generate a speed-dependent damping force that is roughly independent from the immediately preceding excitation movement of the damper. This speed-dependent damping force is set essentially with the aim of achieving a highly stable vehicle body and therefore also a high degree of driving safety. The damper speeds are low, and the amplitudes are relatively large. However, the smaller amplitudes at middle and higher frequencies which have a similar speed level are also highly attenuated in these vibration dampers, which leads to loss of comfort. If these frequencies were weakly attenuated, comfort would be appreciably improved at lower to medium speeds, for example, in city traffic. This goal could be achieved with a primarily frequency-dependent damping, preferably in rebound direction.

Damping valve arrangements with a frequency-dependent damping force characteristic are known in the art. They are outfitted with an additional electronic and/or mechanical control and switch an additional damping valve arrangement on or off depending on a compression frequency and/or rebound frequency of the vibration damper.

DE 44 41 047 C1 or JP6207636 A2 may be cited as examples.

There are also known solutions having a control arrangement arranged at the piston rod coaxial to the damping piston and comprises a control pot and an axially displaceable control piston arranged in the control pot. The control piston axially limits a control space enclosed in the control pot and connected to the damping valve arrangement via an inlet connection. A spring element is arranged between the control piston and damping valve, which spring element introduces a spring force axially into the control piston on the one hand and into the damping valve on the other hand. When the control space is filled with damping medium, the control piston displaces in direction of the damping valve and, via the spring element, increases the pressing pressure of the valve disks of the damping valve, which increases the damping force.

However, all known damping valve arrangements stand out as highly complicated, which drives up production costs and requires a very highly precise adjustment.

### SUMMARY OF THE INVENTION

It is an object of the present invention to provide a simply constructed, economical damping valve arrangement which has a frequency-dependent damping force characteristic.

According to one aspect of the invention, the surface of the control piston facing the control space is greater than a surface of the valve disk bounded by the flow channel, and a smallest cross-sectional area Az of the inlet connection opening into the control space and a smallest cross-sectional area Aa of the outlet connection leading out of the control space are dimensioned such that their ratio to one another is between 0.2 and 5 according to the condition Az/\sqrt{Aa}.

Accordingly, the control space is filled with the damping fluid during a low-frequency excitation movement of the damping valve arrangement inside the cylinder so that the control piston is axially displaced in direction of the check valve and tensions the spring element, and the spring element loads the valve disks with a higher spring tension, thereby increasing the damping force.

During smaller high-frequency excitation movements of the damping valve arrangement inside the cylinder, the control space is not filled or only slightly filled, so that the spring element is not further preloaded and the damping force is not further increased.

According to an advantageous construction variant, the inlet connection has at least one bypass formed at the piston rod, at least one flow recess connecting the bypass to the first working space, and at least one inlet restrictor connecting the bypass to the control space.

The bypass can be realized, for example, by a partial radial flattening of the piston rod.

According to a further advantage, the outlet connection can be formed at least partially from a defined leakiness between the control piston and the pot wall of the control pot. This leakiness can be magnified through a stamping in the wall of the control pot or by a rough surface texture of these structural component parts.

To empty the control chamber faster and, accordingly, to return the control piston in the control pot of the control arrangement faster, it can be quite advantageous when the outlet connection comprises an outlet restrictor formed at the control pot and/or at the control piston.

Investigations have shown that it is particularly advantageous when the smallest cross-sectional area of the inlet connection has an extension of between 0.1 mm² and 4 mm² and when the smallest cross-sectional area of the outlet connection has an extension of between 0 mm² and 8 mm².

### BRIEF DESCRIPTION OF THE DRAWINGS

The invention will be described more fully with reference to the following description of the drawings. In the drawings:

FIG. 1 is a sectional view of an embodiment example of a damping valve arrangement;

FIG. 2 is a sectional view of an alternative embodiment example of a damping valve arrangement.

### DETAILED DESCRIPTION OF THE PRESENTLY PREFERRED EMBODIMENTS

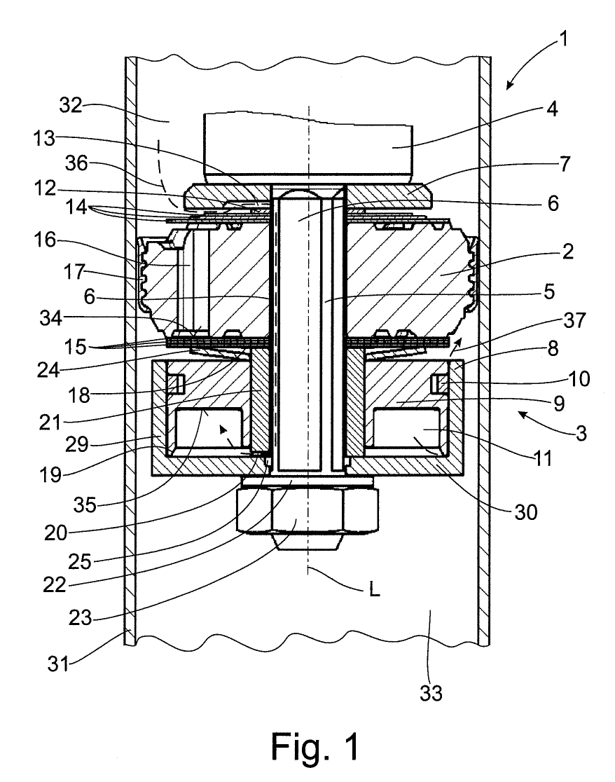

FIG. 1 shows an exemplary construction variant of a damping valve arrangement with a frequency-dependent damping force characteristic.

FIG. 1 shows a piston rod 4, which has a piston rod tenon 5, as it is called. The piston rod tenon 5 is a portion of the piston rod 4 having a reduced diameter. The damping valve arrangement 1 in its entirety is threaded onto the piston rod tenon 5 and is axially clamped between a portion of the piston rod 4, which portion adjoins the piston rod tenon 5 and has a larger diameter than the piston rod 5, and fastener 23 shown in FIG. 1 as a piston rod nut.

As is shown in FIG. 1, the damping valve arrangement 1 comprises a damping piston 2 arranged inside a cylinder 31 filled with a damping fluid and which is axially secured to a piston rod 4. The damping piston 2 is outfitted with a piston seal 17 which radially seals it relative to the cylinder 31. The damping piston 2 which is fixed to the piston rod 4, is arranged to be axially displaceable together with the piston rod 4 inside the cylinder 31, and divides the interior of the cylinder into a first working space 32 on the piston rod side and a second working space 33 remote of the piston rod 4.

The damping piston 2 is outfitted in each instance with a check valve in each flow direction of the damping fluid. The check valves comprise in each instance at least one flow channel 16 formed in the damping piston 2 covered by at least one valve disk 15. As is shown in the drawings, the flow channels 16 can be covered by a plurality of valve disks 14; 15, which are stacked one upon the other, known as valve disk packages. The quantity, size and shape of the individual valve disks 14; 15 in a valve disk package define the pressing pressure, damping characteristic and damping behavior of a vibration damper.

A control arrangement 3 is arranged at the piston rod 4 coaxial to the damping piston 2. Control arrangement 3 comprises a control pot 8 and a control piston 9, which is axially displaceable in the control pot 8. Control pot 8 has a cylindrical pot wall 29 and a disk-shaped pot base 30 arranged at an end of the control pot 8 remote of the damping piston 2.

On the side facing the check valve, the control piston 9 arranged in the control pot 8 axially limits a control space 11 enclosed in the control pot 8 so that an axial displacement of the control piston 9 inside the control pot 8 changes the volume of the control space 11 in a defined manner.

The damping valve arrangement 1 further has an inlet connection 36, which connects the first working space 32 to the control space 11. In the construction variant shown in FIG. 1, this inlet connection 36 comprises a bypass 6 formed at the piston rod 4, at least one flow recess 13 connecting the bypass 6 to the first working space 32, and at least one inlet restrictor 20 connecting the bypass 6 to the control space 11.

The damping valve arrangement 1 further has an outlet connection 37, which connects the control space 11 to the second working space 33.

The inlet restrictor 20 may be realized in a variety of ways such as, for example, through bore holes or stamps. More complicated valves are also conceivable as inlet resistance relative to the control space 11, for example, a pressure-limiting valve that permits flow into the control space 11 only above a pressure that can be adjusted. These construction variants are not shown in the drawings, but can nevertheless be implemented for purposes of the present invention.

In the construction variants shown in the drawings, a tubular guide bushing 21 is arranged between the damping piston 2 and the pot base 30 of the control arrangement 3 to implement a tension chain of the damping valve arrangement 1.

The control piston 9 extends around the guide bushing 21 radially and slides axially on the outer surface of the guide bushing 21 during a change in volume of the control space 11.

A spring element 24 in the form of a disk spring is arranged between the control piston 9 and the check valve. This spring element 24 is axially supported at the control piston 9 on the one hand and at the valve disk 15 of the check valve on the other hand. Accordingly, the spring element 24 loads the valve disk 15 axially in direction of the flow channel 16 and the control piston 9 in direction of the pot base 30 with a defined spring force. The control piston 9 has a stop 19 that limits the axial movement of the control piston 9 in direction of the pot base 30. The preloading force of the spring element 24 is smallest in the position of the control piston shown in the figure, so that a small, defined damping force level is achieved.

The control piston 9 is approximately tight on the radially inner side and outer side in comparison to the smallest cross section of the inlet connection 36. However, a defined leakiness can be provided between the control piston 9 and the pot wall 29 of the control pot 8, which at least partially defines the outlet connection 37.

Accordingly, the surface 35 of the control piston facing the control space 11 is greater than a surface 34 of the valve disk 15 bounded by the flow channel 16. This means that the axial surface 35 of the control piston 9 acted upon by the increasing pressure of the damping medium when the piston rod 4 moves out of the cylinder 31 i.e., the pressure-impinged axial surface 35 is greater than the pressure-impinged axial surface 34 of the check valve on the rebound side.

It is important that the smallest cross-sectional area Az of the inlet connection 36 opening into the control space 11 and a smallest cross-sectional area Aa of the outlet connection 37 leading out of the control space 11 are dimensioned such that their ratio to one another is between 0.2 and 5 according to the condition Az/\sqrt{Aa}.

When there is a pressure increase in rebound direction, the damping medium is conveyed into the control space 11 in a restricted manner through the smallest cross-sectional area Az of the inlet connection 36 opening into the control space 11. The control piston 9 is displaced and further preloads the spring element 24, which is axially supported at the valve disk 15 of the check valve, so that the damping force of the check valve is increased.

During rapid, smaller axial movements of the damping piston 2 inside the cylinder 31, the control space 11 is only filled partially, or not at all, so that the spring element 24 is not preloaded further and the damping force remains at a defined low level. However, during larger, slower axial movements of the damping piston 2 inside the cylinder 31, the integral of the pressure differential of damping fluid pressure on the valve disk 15 to damping fluid pressure in the control space 11 over time is large enough, in spite of the throttling resistance of the inlet connection 36, to supply the control space 11 with enough damping fluid so that the control piston 9 preloads the spring element 24 until the control piston 9 encounters a stop disk 18 arranged between the guide bushing 21 and the valve disks 15 of the check valve. The stop disk 18 limits the axial movement of the control piston 9 in direction of the damping piston 2 and accordingly defines the maximum preloading of the spring element 24 and, therefore, also the highest damping force characteristic.

After the reversal of the piston rod movement, the damping fluid pressure drops again. The spring element 24 preloaded by the control piston 9 displaces the damping fluid back again via the control piston 9, predominantly via the inlet connection 36, into the working space 32 on the piston rod side.

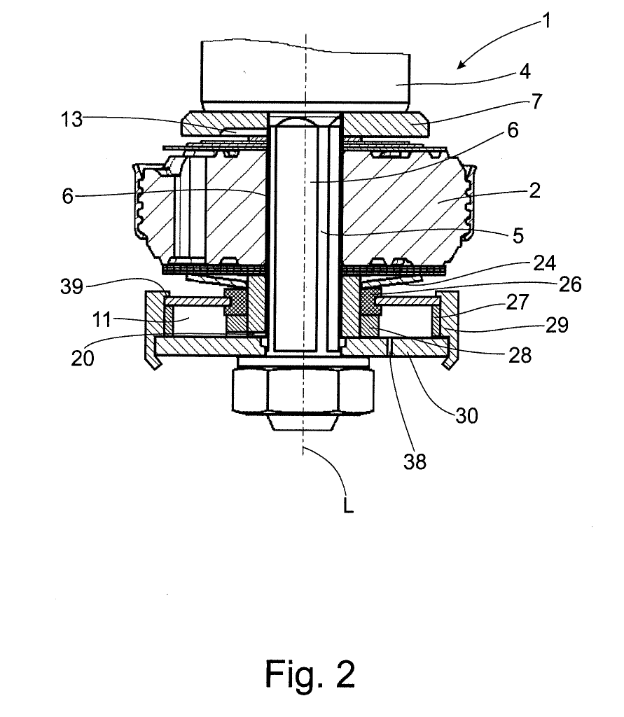

As is shown in FIG. 2, the control space 11 can alternatively have a separate outlet restrictor 38 that leads to the working space away from pressure. This separate outlet restrictor 38 can also be arranged in the control piston 9. The advantage consists in that the control piston 9 moves back faster during the pressure drop.

The difference between FIG. 1 and FIG. 2 consists in the simplified construction of the control arrangement 3. The control pot 8 comprises a separate pot wall 29 and a separate pot base 30 that are joined together and fixedly connected to one another by deforming the pot wall 29. The connection of these two structural component parts can be carried out by positive engagement, frictional engagement or bonding engagement.

The control piston 9 is constructed in a disk-shaped manner in FIG. 2 and comprises an elastic material. The control piston 9 is supported by its outer circumference in an axially fixed manner at an edge 39 formed at the pot wall 29 on the one hand and, on the other hand, at a radially outer supporting element 27 arranged inside the control space 11 and radially contacts the inner surface of the pot wall 29.

The edge portion of the disk-shaped control piston 9 facing the piston rod 4 is supported radially centrally at a sliding element 26, which is preferably made of plastic, extends in circumferential direction around the guide bushing 21, and is axially movable inside the control space 11. A radially inner supporting element 28 which is arranged inside the control space 11 and extends around the guide bushing 21 to serve as a stop for limiting an axial movement of the control piston 9 connected to the sliding element 26. The sliding element 26 is axially supported by the spring element 24 for defining the low damping force level with a “soft” damping force characteristic. The very short construction and the use of simple component parts are advantageous in this construction variant.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A damping valve arrangement for a vibration damper, comprising:
a cylinder that is at least partially filled with a damping fluid;
piston rod;
an axially displaceable damping piston arranged inside the cylinder and is axially secured to the piston rod, the damping piston divides the cylinder into a first working space on the piston rod side and a second working space remote of the piston rod;
at least one check valve arranged in the damping piston comprising at least one flow channel formed in the damping piston;
at least one valve disk that covers the at least one check valve;
a control arrangement arranged at the piston rod coaxial to the damping piston, comprising:
has a control pot with a cylindrical pot wall;
a disk-shaped pot base arranged at an end of the control pot remote of the damping piston;
an axially displaceable control piston arranged in the control pot that axially limits a control space enclosed in the control pot on a side facing the at least one check valve;
an inlet connection that connects the first working space to the control space; and
an outlet connection that connects the control space to the second working space; and
a spring element arranged between the control piston and the at least one check valve configured to load the at least one valve disk axially in direction of the at least one flow channel and the control piston in direction of the disk-shaped pot base with a defined spring force;
wherein a surface of the control piston facing the control space is greater than a surface of the at least one valve disk bounded by the at least one flow channel, and
a smallest cross-sectional area of the inlet connection opening into the control space and a smallest cross-sectional area of the outlet connection leading out of the control space are dimensioned such that their ratio to one another is between 0.2 and 5 according to Az/\sqrt{Aa}.

8. The damping valve arrangement for a vibration damper according to claim 7, wherein
the inlet connection has at least one bypass formed at the piston rod,
at least one flow recess connecting the at least one bypass to the first working space, and
at least one inlet restrictor connecting the at least one bypass to the control space.

9. The damping valve arrangement for a vibration damper according to claim 7, wherein the outlet connection comprises at least partially a defined leakiness between the control piston and the cylindrical pot wall of the control pot.

10. The damping valve arrangement for a vibration damper according to claim 7, wherein the outlet connection comprises an outlet restrictor formed at least at one of the control pot and the control piston.

11. The damping valve arrangement for a vibration damper according to claim 7, wherein a smallest cross-sectional area of the inlet connection has an extension of between 0.1 mm² and 4 mm².

12. The damping valve arrangement for a vibration damper according to claim 7, wherein a smallest cross-sectional area of the outlet connection has an extension of less than or equal to 8 mm².

13. The damping valve arrangement for a vibration damper according to claim 9, wherein the outlet connection comprises an outlet restrictor formed at least at one of the control pot and the control piston.
